(19) United States
(12) Patent Application Publication
(10) Pub. No.: US 2007/0091356 A1
(43) Pub. Date: Apr. 26, 2007

(54) System and method for extending printing functionality to multiple printers

(75) Inventor: Karl Heinz Kremer, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/259,292

(22) Filed: Oct. 26, 2005

(51) Int. Cl. G06F 3/12

(52) U.S. Cl. 358/1.15; 358/1.13

(57) ABSTRACT

In a system and a method for extending printing functionality implemented for a first printer to a second printer, a first set of functions applicable to the first printer is identified, and a second set of functions applicable to the second printer is identified. Functions in the first set of functions are matched with functions in the second set of functions, and matching data describing the matched functions is stored in a computer-accessible memory. The matching data is capable of facilitating printing a print job with the second printer, the print job being originally configured for printing with the first printer. Accordingly, from the perspective of a manufacturer of the first printer, new functions need not be developed to print to the second printer, which may be manufactured by another manufacturer.

### FIELD OF THE INVENTION

This invention relates to extending printing functionality that exists for one or more printers to one or more other printers. In particular, this invention pertains to extending existing printing functionality to support one or more printers for which the existing printing functionality may not have been originally intended.

### BACKGROUND OF THE INVENTION

In today's marketplace, several organizations design and manufacture high-volume/high complexity printing devices. Conventionally, when these organizations develop a printer, they develop software that controls the printer to perform the various functions and tasks required of the printer. These functions and tasks collectively are referred to herein as printing functionality. Depending on the printer, printing functionality may include printing an image with a certain resolution, printing an image in color, greyscale, or black and white, printing on a certain paper size, printing on a certain type of print media, stapling a printed document in one or more various locations, etc. Due to the complexity of the printing devices at issue, the functionality offered by one printer may be significantly different from the functionality of another printer. Therefore, developing the software required to implement printing functionality is, often times, a customized process tailored to each printer manufactured by an organization.

Further, organizations have not been able to develop software that simply and effectively controls another organization's printers. In particular, organizations typically guard the contents of their printer-control software, thereby making if difficult for other organizations to write software that controls all of the features offered by their competitors' printers. From a customer's perspective, it would be useful to have one printer-control software package that controls all of the printers that the customer owns. To elaborate, it is common for a customer to own printers manufactured by different organizations. Conventionally, these customers have to learn how to use a different printer-control software package for each printer or group of printers manufactured by a different organization. For example, if a customer owns a first printer manufactured by “company A” and a second printer manufactured by “company B”, he or she must learn how to use company A's software to control the first printer and company B's software to learn how to use the second printer. This conventional arrangement is inconvenient for customers, and, accordingly, a need exists in the art for a universal software package that can control multiple printers in a manufacturer-independent manner.

### SUMMARY OF THE INVENTION

The above-described need is addressed and a technical solution is achieved in the art by a system and a method for extending printing functionality implemented for a first printer to a second printer according to the present invention. In an embodiment of the present invention, a first set of functions implemented for the first printer is identified, and a second set of functions applicable to the second printer is identified. The functions in the second set of functions may be identified as links to function calls or commands, or as the function calls or commands themselves, which are used by the second printer to execute the actual software code implementing such functions. An advantage of this arrangement is that the actual software code implementing the functions applicable to the second printer need not be known. According to an embodiment of the present invention, the functions in the second set of functions may be identified by reading a PostScript® Printer Description (“PPD”) file that describes the functions that are available to the second printer without disclosing the actual software code used to execute such functions. (PostScript is a registered trademark of Adobe Systems Incorporated located in Palo Alto, Calif.) Functions in the first set of functions are matched with functions in the second set of functions, and the matched functions are stored in a computer-accessible memory. This matching may occur by the assistance of a person, e.g. via a computer-implemented user interface, and/or by the assistance of a computer. The matched functions are used to facilitate printing a print job with the second printer, where the print job was originally configured to print to the first printer.

Accordingly, from the perspective of a manufacturer of the first printer, new functions need not be developed to print to the second printer, which may be manufactured by another manufacturer. Instead, because functions applicable to the first printer are matched with functions applicable to the second printer, function calls or commands developed for the first printer may be simply substituted with function calls or commands used to print to the second printer. Further, the present invention allows the functionality of the first printer to be extended to the second printer without having to develop new complex software to do so. Because the present invention allows a manufacturer of the first printer to easily print to a second printer from another manufacturer, the manufacturer of the first printer can incorporate support for the second printer into its printer-control software package. Accordingly, customers may be provided with a single printer-control software package capable of printing to multiple printer manufacturer-independent manner.

### BRIEF DESCRIPTION OF THE DRAWINGS

The present invention will be more readily understood from the detailed description of preferred embodiments presented below considered in conjunction with the attached drawings, of which:

FIG. 1 illustrates a system for preparing a function map, according to an embodiment of the present invention;

FIG. 2 illustrates a method for preparing a function map, according to an embodiment of the present invention;

FIG. 3 illustrates a user interface for preparing a function map, according to an embodiment of the present invention;

FIG. 4 illustrates a system for printing to a third party printer, according to an embodiment of the present invention; and

FIG. 5 illustrates a method for printing to a third party printer by using a function map, according to an embodiment of the present invention.

It is to be understood that the attached drawings are for purposes of illustrating the concepts of the invention and may not be to scale.

### DETAILED DESCRIPTION

The present invention allows software functions that were developed to control a first printer (e.g., a proprietary printer) to be used to control one or more second printers (e.g. non-proprietary or third party printers). Accordingly, the present invention allows a printer-manufacturing organization's existing software to control third party printers without significant time and financial commitments. Further, the present invention allows a printer-manufacturing organization to provide a single, universal printer-control software package to their customers that is manufacturer independent.

Although embodiments of the present invention often are described in the context of proprietary and third party printers, one skilled in the art will appreciate that the invention also applies to extending printing functionality from one printer to another printer regardless of who manufactures and/or supports the other printer. Further, although the invention often is described in the context of extending printing functionality from one printer to another printer, one skilled in the art will appreciate that the invention also applies to extending nearly any software function, not just a printer function, from one application to another.

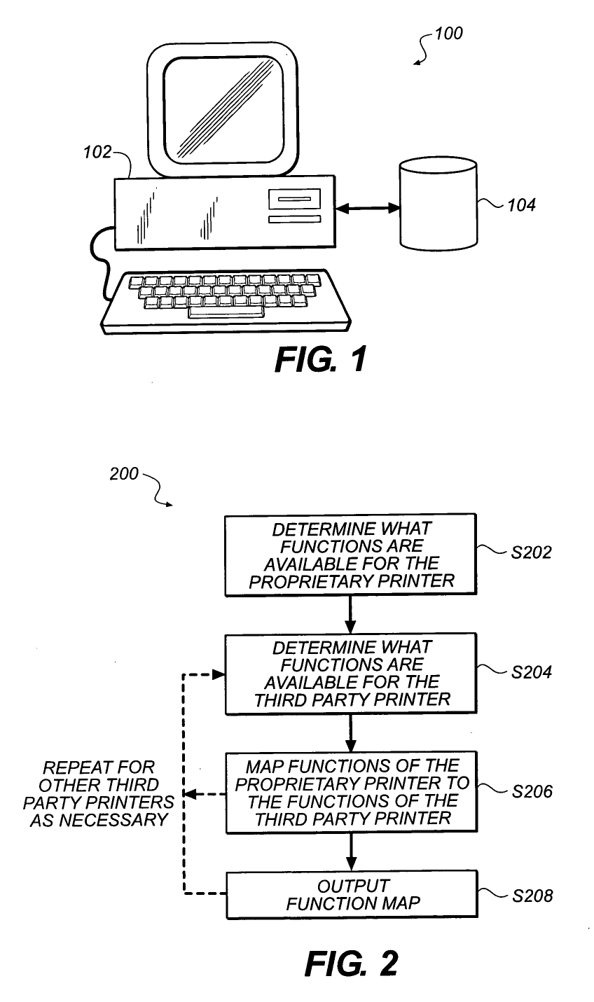

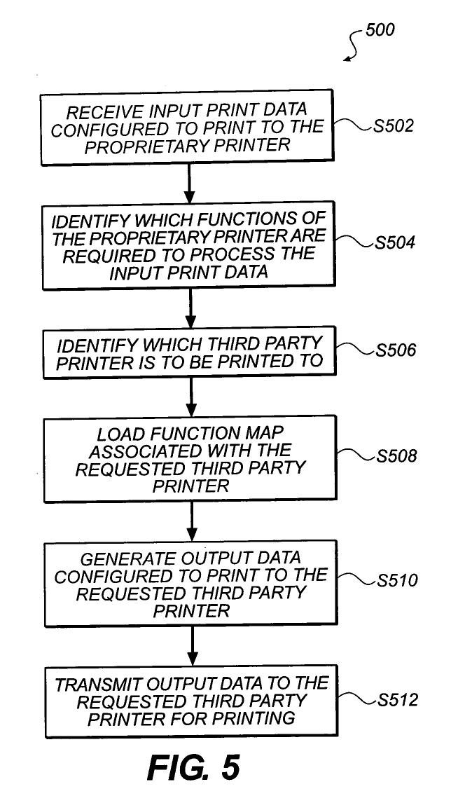

According to an embodiment of the present invention, printing functionality is extended from for one or more supported proprietary printers to one or more other third party printers in two independent stages. The first stage involves generation of a function map which matches associated functions of one or more proprietary printers to one or more third party printers. The first stage is described in detail below with respect to FIGS. 1-3. The second stage involves receiving a print job configured for printing to a proprietary printer, converting, using an applicable function map, the print job for printing with a third party printer, and printing the converted print job with the third party printer. The second stage is described in detail below with respect to FIGS. 4 and 5.

Turning now to FIG. 1, a system 100 for preparing a function map, according to an embodiment of the present invention, is illustrated. The system 100 includes a computer 102 communicatively connected to a data storage system 104. Although a single computer 102 is shown, one skilled in the art will appreciate that a plurality of computers communicatively connected may be used in place of the computer 102 to accomplish the same tasks described below.

The term “computer” is intended to include any data processing device, such as a desktop computer, a laptop computer, a mainframe computer, a personal digital assistant, a Blackberry, and/or any other device for processing data, and/or managing data, and/or handling data, whether implemented with electrical and/or magnetic and/or optical and/or biological components, and/or otherwise.

The data storage system 104 may include one or more computer-accessible memories. The data storage system 104 may be a distributed data storage system including multiple computer-accessible memories communicatively connected via a plurality of computers and/or devices. On the other hand, the data storage system 104 need not be a distributed data storage system and, consequently, may include one or more computer-accessible memories located within a single computer or device.

The phrase “computer-accessible memory” is intended to include any computer-accessible data storage device, whether volatile or nonvolatile, electronic, magnetic, optical, or otherwise, including but not limited to, floppy disks, hard disks, Compact Discs, DVDs, flash memories, ROMs, and RAMs. The phrase “communicatively connected” is intended to include any type of connection, whether wired, wireless, or both, between devices, and/or computers, and/or programs in which data may be communicated. Further, the phrase “communicatively connected” is intended to include a connection between devices and/or programs within a single computer, a connection between devices and/or programs located in different computers, and a connection between devices not located in computers at all. In this regard, although the data storage system 104 is shown separately from the computer 102, one skilled in the art will appreciate that the data storage system 104 may be stored completely or partially within the computer 102.

According to an embodiment of the present invention, the system 100 is used to implement the method 200 depicted in FIG. 2. The method 200 illustrates exemplary steps involved in generating a function map which includes a matching of functions for controlling a proprietary printer with functions for controlling a third party printer. The method 200 may be performed, at least in part, by a person with the assistance of the computer 102, or may be automatically performed, at least in part, by the computer 102. Further, although the method 200 is illustrated as having a particular ordering, one skilled in the art will appreciate that the invention is not limited to such ordering. For example, step S 202 and step S 204 may occur in opposite order.

The method 200 begins at step S 202, which determines what functions, or printing functionality, are/is available for the proprietary printer. Examples of such functions may include printing an image with a certain resolution, printing an image in color, greyscale, or black and white, printing on a certain paper size, printing on a certain type of media, stapling a printed document in one or more various locations, or any other function, known in the art, performed by a printer.

According to an embodiment of the present invention, an identification of the functions available for the proprietary printer may be stored as electronic data in the data storage system 104. Assuming that the functions for controlling the proprietary printer were developed by the entity or organization for which the method 200 is performed, such electronic data.may be prepared from knowledge provided by the entity or organization. For example, if “company A” has an employee perform the method 200 at computer 102, company A might prepare electronic data describing the names and function calls associated with the functions available for the proprietary printer. This electronic file may be stored in the data storage system 104 and retrieved by the computer 102 in order to complete the step S 202. In the event that the method 200 is performed without the assistance of an operator at the computer 102, the computer 102 may be programmed to retrieve the electronic data from the data storage system 104 automatically. The electronic data could be a PostScript Printer Description (“PPD”) file, known in the art, that describes the functions available for the proprietary printer. However, the electronic file could be a text file, a spreadsheet file, or any other data file or data format capable of identifying the functions available for the proprietary printer. If a PPD file is used at step S 202, a portion of it may appear, for example, as the right-hand column of the Example A Table, below.

EXAMPLE A
Sample Portion of a First PPD File

| | |
|---|---|
| Line 1: | *OpenUI *StapleType/Staple: PickOne |
| Line 2: | *DefaultStapleType: Top |
| Line 3: | *StapleType Top/Top: “<</Staple(Top)>>” |
| Line 4: | *StapleType Bottom/Bottom: “<</Staple(Bottom)>>” |

As is known in the art, PPD files describe the features or functions available to a printer and also describe the manner in which a user may activate one or more of those functions for a particular print job. Line 1 in Example A, above, indicates that when a PostScript print job is to be printed, a user interface is to be displayed (“OpenUI”) allowing a user to select one (“PickOne”) of the available “Staple” functions identified within the PPD file by the reference “StapleType”. Line 2 in Example A indicates that the default StapleType function is the “Top” function, which, in this example, is a function for stapling a document at its top. Accordingly, in the displayed user interface, the “Top”function would be initially selected. Line 3 in Example A indicates that the first StapleType function is the “Top” function and that the PostScript command (also referred to as a function call) for executing this function is “<</Staple(Top)>>”. In other words, if a user selects the “Top” function from the displayed user interface, the command sent to the printer to execute the actual software code associated with this function is “<</Staple(Top)>>”. The fourth line of code in Example A indicates that the second StapleType function is the “Bottom” function and that the PostScript command for executing this function is “<</Staple(Bottom)>>”. To summarize, as a program reads the PPD file for printing a print job, it may display a drop-down list entitled, “Staple” where the options available in the drop-down list are “Top” and “Bottom” and the “Top” function is initially selected. According to an embodiment of the present invention, however, the PPD file may be accessed merely to determine which functions are available for the proprietary printer at step S 202.

At step S 204, the functions available for the third party printer for which printing functionality is to be extended to are determined. Such a determination may occur by accessing an electronic file, such as a PPD file, that describes the names and function calls associated with the functions available for the third party printer. However, any method of determining such functions may be used. If a PPD file is used to make the determination at step S 204, a portion of it may appear, for example, as the right-hand column of the Example B Table below.

EXAMPLE B
Sample Portion of a Second PPD File

| | |
|---|---|
| Line 1: | *OpenUI *FinishingType/Finishing: PickOne |
| Line 2: | *DefaultFinishingType: Single Portrait Staple |
| Line 3: | *FinishingType SinglePortraitStaple/Single Portrait |
| | Staple: |
| | “<</Finishing(Single Portrait Staple)>>” |
| Line 4: | *FinishingType SingleLandscapeStaple/Single |
| | Landscape Staple: |
| | “<</Finishing(Single Landscape Staple)>>” |

For the purposes of step S 204, Example B indicates that two finishing functions are provided for the third party printer: a SinglePortraitStaple function and a SingleLandscapeStaple function. The associated PostScript commands for executing these functions on the third party printer are “<</Finishing(Single Portrait Staple)>>”and “<</Finishing(Single Landscape Staple)>>”, respectively.

As can be seen with a comparison of Example A and Example B, the proprietary printer associated with step S 202 and the third party printer associated with step S 204 may have functions with different names that accomplish the same task, e.g., the StapleType Top function and the FinishingType SinglePortraitStaple function, respectively place a staple at the top of a document. Further, although not shown in Example A and Example B, the proprietary printer and the third party printer may have functions not supported on the other.

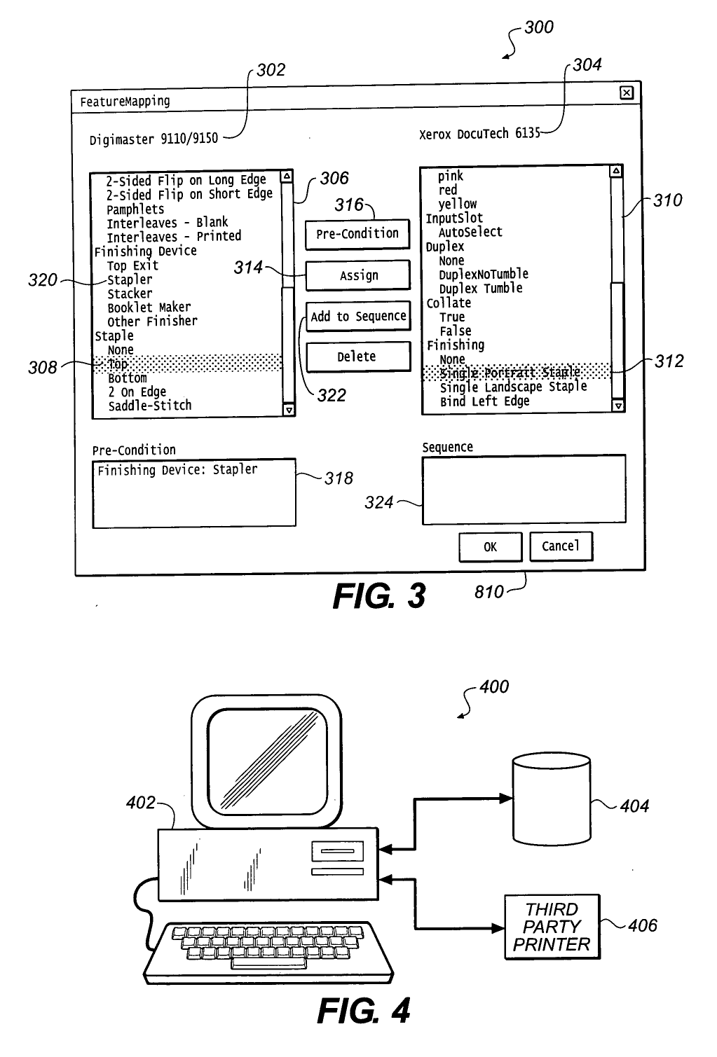

Having identified the set of functions associated with the proprietary printer at step S 202 and the set of functions associated with the third party printer at step S 204, the third party printer functions needed to implement one or more of the proprietary printer functions are matched at step S 206. An example of a user interface 300 displayed on the computer 102 for performing this matching is illustrated with FIG. 3. The user interface 300 may include an identification of the proprietary printer 302 and an identification of the third party printer 304.

In a scroll-down box 306, a list of the functions available for the proprietary printer 302 is displayed. For example, the StapleType Top function of line 3 of Example A is illustrated at line 308 in the scroll-down box 306. In a scroll-down box 310, a list of the functions available for the third party printer 304 is displayed. For example, the FinishingType SinglePortraitStaple function of line 3 of Example B is illustrated at line 312 in the scroll-down box 310. In the user interface 300, a user may determine that the Staple:Top function of the proprietary printer 302 in line 308 matches the Finishing:SinglePortraitStaple function of the third party printer 304 in line 312. The user may indicate this match by selecting the line 308 with a mouse click, selecting the line 312 with a mouse click, and then selecting the “Assign” button 314. In the event that the proprietary printer 302 includes functions not available to the third party printer 304, or vice-versa, such functions may be left out of the matching process and marked as unsupported.

If a pre-condition is required to execute one of the proprietary printer functions in box 306, the pre-condition may be indicated by identifying the pre-condition and then selecting the “Pre-Condition” button 316. For example, it may be required that a software check be made to ensure that a stapling device exists prior to allowing the execution of a stapling function. To indicate this pre-condition, an operator of the user interface 300 may select a function that reflects this software check (e.g., by selecting line 320) and then selecting the “Pre-condition” button 316. After selecting the “Pre-Condition” button 316, the pre-condition is reflected in the box 318.

Sometimes, it may be necessary to execute more than one third party-printer function to execute a proprietary-printer function in the box 306, or vice versa. According to an embodiment of the present invention, the operator of the interface 300 may select a proprietary-printer function in the box 306 and then select one or more third party-printer functions (or vice versa) in the box 310 in the order required to execute the counterpart function. After such selections, the operator may select the “Assign” button 314, which will output the selected sequence of functions in the box 324. Alternatively, the operator can select each required counterpart function at a time and select the “Add to Sequence” button 322 after each selection to build up the sequence displayed in box 324 one function at a time.

It should be noted that, although the description of the example user interface 300 describes a certain procedure for matching functions, one skilled in the art will appreciate that it is immaterial to the invention exactly how functions are matched and that any procedure for matching functions may be used. Further, although the example user interface 300 is designed for interaction with an operator, one skilled in the art will appreciate that the matching process at step S 206 may be completely or partially performed by the computer 102 without the input from an operator. For example, an intelligent parsing program may be written for execution by the computer 102 that could make best-guess matches between functions based upon the function names illustrated in boxes 306 and 310.

After the functions have been matched at step S 206, a function map, or data structure containing information that describes the matching of functions between the proprietary printer, 302, for example, and the third party printer, 304, for example, is output at step S 208. The function map output at step S 208 may be transmitted to the data storage system 104 for storage. Steps S 204 and S 206 may be repeated for other third party printers, such that a single function map pertaining to all third party printers may be output at step S 208. Alternatively, steps S 204, S 206, and S 208 may be repeated for other third party printers, such that one function map is output at step S 208 for each third party printer. Similarly, the entire method 200 may be repeated for other proprietary printers. Regardless of the process chosen, new function maps may be output at step S 208 or, alternatively, the new matching data generated at each step S 206 may be incorporated into an existing function map at step S 208. One skilled in the art will appreciate that any manner of outputting, storing, or organizing the function map(s) may be used.

Turning now to FIG. 4, a system 400 a system for printing to a third party printer, according to an embodiment of the present invention, is illustrated. The system 400 includes a computer 402 communicatively connected to a data storage system 404 and a third party printer 406. Although a single computer 402 is shown, one skilled in the art will appreciate that a plurality of computers communicatively connected may be used in place of the computer 402 to accomplish the same tasks described below.

The data storage system 404 stores at least the function map(s) generated with the method 200 and, consequently, may (or may not) be the same data storage system as system 104. The data storage system 404 may include one or more computer-accessible memories. The data storage system 404 may be a distributed data storage system including multiple computer-accessible memories communicatively connected via a plurality of computers and/or devices. On the other hand, the data storage system 404 need not be a distributed data storage system and, consequently, may include one or more computer-accessible memories located within a single computer or device. Although the data storage system 404 is shown separately from the computer 402, one skilled in the art will appreciate that the data storage system 104 may be stored completely or partially within the computer 402.

According to an embodiment of the present invention, the system 400 is used to implement the method 500 depicted in FIG. 5. The method 500 illustrates exemplary steps involved in printing a print job originally configured for a proprietary printer to a third party printer by utilizing a function map generated according to the method 200. The method 200 may be performed, at least in part, by a person with the assistance of the computer 402, or may be automatically performed, at least in part, by the computer 402. The print job may be received by the computer 402 via manual entry from a user interface at the computer 402, may be received by the computer 402 from another computer (not shown in FIG. 4) communicatively connected to the computer 402, or may be received by retrieving a stored print job from the data storage system 404.

It should be noted that, although the method 500 is illustrated as having a particular ordering, one skilled in the art will appreciate that the invention is not limited to such ordering. For example, step S 504, step S 506, and step S 508 may occur in any order after step S 502 and before step S 510.

At step S 502, input print data (a “print job”) configured to print to a proprietary printer is received by the computer 402. The print job may include data describing the image(s) to be printed, an identification of the functions required by the proprietary printer to print the print job, and which third party printer the print job is to be printed. According to an embodiment of the present invention, at least a portion of the input print data adheres to the Portable Document Format (“PDF”), known in the art. For the sake of an example, the input data may contain the information shown in Table I, below.

TABLE I
Example Contents of Input Print Data

| | |
|---|---|
| Format of Data Describing | PDF |
| Image(s) to be Printed: | |
| Functions Required by Proprietary | Staple Top of Document |
| Printer: | Print 5th Page Green |
| Desired Third Party Printer: | Printer X |

Input print data having the contents shown in Table I could be transmitted to the computer 402 at step S 502 as a PDF file describing the data to be printed on each page of a document and as one or more associated files describing (a) the functions required by the proprietary printer to print/complete the print job and (b) what third party printer should print the print job. Alternatively, information describing the functions required by the proprietary printer to print/complete the print job and the third party printer(s) that will print the print job may be embedded within the PDF file that describes the data to be printed on each page of a document. Accordingly, one skilled in the art will appreciate that the input print data may be transmitted in any manner and may be stored in one or more files. Although the sample contents of input print data shown in Table I include the PDF format to describe the document to be printed, one skilled in the art will appreciate that other formats may be used. For instance, any Page Description Language (“PDL”) format, known in the art, may be used, such as PostScript. If PostScript is used, the input print data could be transmitted to the computer 402 at step S 502 as (a) a PostScript document, which includes a description of the data to be printed on each page of a document, as well as the functions required by the proprietary printer to print/complete the print job, and (b) a file describing which third party printer should print the print job. In this situation, the PostScript document may include one or more of the PostScript commands described in the proprietary printer's PPD file. (See Example A, above, for instance.) From the information stored in the print job, the computer 402 identifies which functions from the proprietary printer are needed to print the print job at step S 504 and identifies which third party printer is to print the print job at step S 506. Further, the computer 402 determines which function map applies to the selected proprietary printer/third party printer combination. The computer 402 accesses the appropriate function map at step S 508 from the data storage system 404.

At step S 510, output data configured to print the print job to the requested third party printer is generated by the computer 402. According to an embodiment of the present invention, the output data includes a PostScript document and is generated utilizing the function map accessed at step S 508. One skilled in the art will appreciate, however, that other output data formats, such as other Page Description Language formats may be used, depending upon the type of third party printer being printed to.

If the input print data from step S 502 is in the PDF format, the input print data may be converted at step S 510 into PostScript output data by using Adobe Acrobat®'s built-in capabilities. (Acrobat is a registered trademark of Adobe Systems Incorporated located in San Jose, Calif. 95110.) In particular, Acrobat provides the ability to output a PDF document as a PostScript document. Acrobat accomplishes this task by generating a PostScript output stream that instructs a PostScript printer on how to print the PDF document segment by segment, e.g. page by page, in a sequential manner. The output stream, upon completion, is stored as the output PostScript document and is ready to be sent to a PostScript printer for printing.

Acrobat allows a software module to be integrated with it (e.g., a plug-in, known in the art) to manipulate or modify the PostScript output stream at particular times (i.e., when particular events occur) as the output stream is being generated. Acrobat accomplishes this task by sending notifications to the software module at these various points of time indicating to the software module that instructions may be inserted into the PostScript output stream at that time. For example, Acrobat issues a “PSPrintAfterBeginPageSetup” notification every time a page of the document to be printed is to be written to the PostScript output stream. Upon receipt of this notification, the software module can insert one or more PostScript commands into the PostScript output stream. With this notification, the software module has the ability to insert PostScript commands that are needed on a page-by-page basis. For example, if the-software module desires to have the fifth page of the output PostScript document printed on green paper (when the other pages are printed on a default white paper), the software module can insert such a command into the PostScript output stream upon receipt of the fifth “PSPrintAfterBeginPageSetup” notification.

Another event that triggers an Acrobat notification is the “PSPrintAfterBeginSetup” event, which occurs only once per output PostScript document. Accordingly, this event is referred to as a “job level” event. On the other hand, because the “PSPrintAfterBeginPageSetup” event occurs at the start of every page, it is referred to as a “page level” event.

According to an embodiment of the present invention, a software module, such as the one described above, is used to insert the appropriate commands applicable to the selected third party printer into the PostScript output stream. The appropriate commands are determined from the function map retrieved at step S 508 by identifying the third party functions that correspond to the proprietary function calls identified in the input data.

If the input print data from step S 502 includes a PDF document, such PDF document is converted to a PostScript document at step S 510 with the assistance of Acrobat and a software module ‘plugged into’Acrobat as described above. In this case, as the PostScript output stream is being generated by Acrobat, the software module inserts the appropriate third party PostScript commands from the third party printer's PPD file (Example B, for instance). For example, assume that the input print data contains the information shown in Table I. Also assume that a portion of the function map retrieved at step S 508 includes the function references shown in Table II.

TABLE II

| Proprietary Printer Function | Third Party Printer Function |
|---|---|
| StapleType Top | FinishingType SinglePortraitStaple |

As the PostScript output stream is being generated, a “PSPrintAfterBeginSetup” event notification may be issued by Acrobat. This event is a job level event, and accordingly, any functions described in row 3 (of 4) of Table I that pertain to an entire job are inserted into the PostScript output stream at this time. In this example, stapling the document at the top is the only job-level function. The proprietary printer function reference for stapling at the top is the “StapleType Top” function. (See, e.g., Example A). The function map retrieved at step S 508 (Table II, for example) specifies that the “StapleType Top”function reference corresponds to the third party printer's “FinishingType SinglePortraitStaple” function reference. The computer 402 then looks up the PostScript command for the FinishingType SinglePortraitStaple function reference in the third party printer's PPD file. In Example B, above, the PostScript command for this function is: “<</Finishing(Single Portrait Staple)>>”. This PostScript command is then inserted into the PostScript output stream upon receipt of the “PSPrintAfterBeginSetup” event notification. The procedure described in this paragraph is repeated for inserting the third party printer's PostScript command for printing the fifth page of the document on green paper, except that this command is inserted upon receipt of the fifth “PSPrintAfterBeginPageSetup” notification, which is a page-level notification.

The third party printer, when it executes the PostScript document output at step S 510, recognizes the PostScript command “<</Finishing(Single Portrait Staple)>>” and accomplishes stapling of the finished document at its top. Similarly, the third party printer recognizes its PostScript command for printing the fifth page on green paper and completes the requested task. Accordingly, a print job originally configured to print with the proprietary printer is printed by the selected third party printer. Therefore, the functionality provided for the proprietary printer is extended to the third party printer. Further, a customer that owns both the proprietary printer and the third party printer has the option of printing a single print job to either printer through the use of a single software package.

In the case where the input print data includes a PostScript document instead of a PDF document, the PostScript document includes within it all of the PostScript commands for executing the required functions (step S 504) on the proprietary printer. Therefore, the computer 402 at step S 510 scans the input PostScript document for these commands and replaces them with the corresponding PostScript commands for executing the required functions on the third party printer. This replacing occurs with the assistance of the function map retrieved at step S 508 and the third party printer's PPD file.

With reference to the example of Table II, it should be noted that it is advantageous to store the references to the third party functions (e.g., “FinishingType SinglePortraitStaple”) in the function map, as opposed to storing the PostScript command (e.g., “<</Finishing(Single Portrait Staple)>>”) for such functions. When the PostScript command needs to be inserted into the PostScript output stream, it is preferable to retrieve the command from the third party printer's PPD file using the reference to the third party function. This procedure is preferable because the third party printer's PPD file may be updated with new PostScript commands for the same function reference. For example, the “FinishingType SinglePortraitStaple” function may be updated with a PostScript command other than “<</Finishing(Single Portrait Staple)>>”. If the old command “<</Finishing(Single Portrait Staple)>>”was hard-coded into the function map, an error would occur when the third party printer attempts to execute this command. But if only a reference (e.g., FinishingType SinglePortraitStaple) is stored in the function map, the most recent command for this function would be retrieved and no error would occur. Accordingly, using the PPD file to retrieve the PostScript command instead of the function map ensures that the most up-to-date PostScript commands are being used at step S 510. Although this procedure is advantageous, one skilled in the art will appreciate that it is not required and that other procedures for generating an output PostScript document may be used.

Once the output data has been generated at step S 510, it is transmitted to the third party printer for printing at step S 512. In the case of a PostScript document being output at step S 510, such document is transmitted to the selected third party printer for printing.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

PARTS LIST

100 system
102 computer
104 data storage system
200 method
S202 step
S204 step
S206 step
S208 step
300 user interface
302 proprietary printer
304 third party printer
306 scroll-down box
308 line
310 scroll-down box
312 line
314 “assign” button
316 “pre-condition” button
318 box
320 line
322 “add to sequence” button
324 box
400 system
402 computer
404 data storage system
406 third party printer
500 method
S502 step
S504 step
S506 step
S508 step
S510 step
S512 step

What is claimed is:

1. A method for extending printing functionality implemented for a first printer to a second printer, the method comprising the steps of:
identifying a first set of functions applicable to the first printer;
identifying a second set of functions applicable to the second printer;
matching functions in the first set of functions with functions in the second set of functions; and
storing matching data describing the matched functions in a computer-accessible memory, the matching data capable of facilitating printing a print job with the second printer, the print job being originally configured for printing with the first printer.

2. The method of claim 1, further comprising the step of: using the matching data to facilitate printing the print job with the second printer.

3. The method of claim 1, wherein the step of identifying the second set of functions comprises interpreting a PostScript Printer Description (“PPD”) file associated with the second printer.

4. The method of claim 1, wherein the functions in the second set of functions are PostScript functions.

5. The method of claim 1, wherein the functions in the first set of functions and the functions in the second set of functions are PostScript functions.

6. The method of claim 1, wherein the matching step comprises providing a graphical user interface displaying functions in the first set of functions and functions in the second set of functions.

7. The method of claim 1, wherein at least part of the matching step is performed by a computer.

8. The method of claim 1, wherein the matching step comprises matching a plurality of functions in the second set of functions to a single function in the first set of functions.

9. The method of claim 1, further comprising the step of: identifying a pre-condition associated with a function in the first set of functions, the pre-condition being a requirement that must be met prior to executing the function with which the pre-condition is associated.

10. A method for printing a print job with a second printer, the print job being originally configured to be printed by a first printer, the method comprising the steps of:
receiving matching data identifying functions applicable to the first printer and their associated counterpart functions applicable to the second printer; receiving the print job configured to be printed by the first printer;
converting the print job into a converted print job configured to be printed by the second printer, the converting being accomplished at least in part with use of the matching data; and
transmitting the converted print job to the second printer for printing.

11. The method of claim 10, wherein the print job includes a Portable Document Format (“PDF”) document, and the converted print job includes a PostScript document.

12. The method of claim 11, wherein the functions applicable to the second printer are identified in the matching data as PostScript references.

13. The method of claim 12, wherein the converting step includes generating the PostScript document by inserting PostScript commands associated with the PostScript references into the PostScript document at appropriate times identified by a receipt of Acrobat notifications.

14. The method of claim 13, wherein the notifications include a PSPrintAfterBeginPageSetup notification and a PSPrintAfterBeginSetup notification.

15. The method of claim 13, wherein the PostScript commands associated with the PostScript references are determined at least in part by accessing a PostScript Printer Description (“PPD”) file associated with the second printer.

16. The method of claim 10, wherein the print job and the converted print job each include a PostScript document.

17. The method of claim 16, wherein the functions applicable to the first printer are identified in the matching data as first PostScript references, and the functions applicable to the second printer are identified in the matching data as second PostScript references.

18. The method of claim 17, wherein:
the first PostScript references are associated with first PostScript commands, and the second PostScript references are associated with second PostScript commands, and
the converting step includes generating the PostScript document by replacing the first PostScript commands with associated second PostScript commands, as identified by the matching data.

19. A computer-accessible memory storing computer code for implementing a method for extending printing functionality implemented for a first printer to a second printer, wherein the computer code comprises:
code for receiving data identifying a first set of functions applicable to the first printer;
code for receiving data identifying a second set of functions applicable to the second printer;
code for performing matching of functions in the first set of functions with functions in the second set of functions; and
code for storing matching data describing the matched functions in a computer-accessible memory, the matching data capable of facilitating printing a print job with the second printer, the print job being originally configured for printing with the first printer.

20. A method for extending printing functionality implemented for a first printer to a second printer, the method comprising the steps of:
identifying a first set of functions applicable to the first printer;
identifying a second set of functions applicable to the second printer by interpreting a PostScript Printer Description (“PPD”) file associated with the second printer;
providing a user interface displaying on a display functions in the first set of functions and functions in the second set of functions;
identifying a pre-condition associated with a function in the first set of functions, the pre-condition being a requirement that must be met prior to executing the function with which the pre-condition is associated;
receiving matching information provided with assistance from the user interface;
performing matching of functions in the first set of functions with functions in the second set of functions, the matching being performed with assistance from the matching information, and the matching comprising matching functions in the first set of functions with functions in the second set of functions; and
storing matching data describing the matched functions in a computer-accessible memory, the matching data capable of facilitating printing a print job with the second printer, the print job being originally configured for printing with the first printer.
